(19) United States
(12) Patent Application Publication
(10) Pub. No.: US 2010/0024280 A1
(43) Pub. Date: Feb. 4, 2010

(54) Termite Control System and Method

(75) Inventors: James C. Reed, Tucson, AZ (US); Kevin R. Hartman, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: Subterranean Termite Solutions, LLC, Tucson, AZ (US)

(21) Appl. No.: 12/534,625

(22) Filed: Aug. 3, 2009

Related U.S. Application Data
(60) Provisional application No. 61/086,018, filed on Aug. 4, 2008.

(51) Int. Cl. A01M 17/00

(52) U.S. Cl. 43/132.1; 43/124

(57) ABSTRACT

A method and system for delivering termite control material to selected portions of a land mass on which a structure is located are provided. Termite control material is delivered to selected portions of a land mass on which a structure is located, according to a predetermined zoned delivery plan that is based at least on the structure configuration, the entry areas at which entry of termites into the structure is most likely, and the hydraulic limitations of the fluid delivery conduit forming the delivery conduit system. Termite control material is delivered from the fluid delivery conduit system to selected delivery area(s) of the land mass through pressure compensating, root inhibiting emitters at predetermined locations in the fluid delivery conduit of the fluid delivery conduit system with verification of treatment through strategically placed moisture sensors. In one implementation of the principles of the present invention, the predetermined zoned delivery plan is designed to enable termite control material to be delivered to the land mass about the perimeter of the structure. In another implementation, the predetermined zoned delivery plan is designed to enable termite control material to be delivered to area(s) of the land mass that are proximate to locations at which entry of termites into the structure is most likely. In yet another implementation, the predetermined zoned delivery plan is designed to enable deliver termite control material to be delivered to the land mass below the entire foundation of the structure. Thus, the present invention provides a zone based control distribution system with verification of uniform, pesticide distribution.

### RELATED APPLICATION/CLAIM OF PRIORITY

This application is related to and claims priority from provisional application Ser. No. 61/086,018, filed Aug. 4, 2008, which provisional application is incorporated by reference herein.

### BACKGROUND

The present invention relates to a system and method for delivering termite control material to selected portions of a land mass on which a structure is located, independent of the structure's size.

Governmentally regulated chemicals approved for use in the elimination and/or protection barrier for subterranean termites have a limited effective life, typically less than 5 year. This necessitates the need to re-treat on a periodic basis to prevent damage to the structural integrity of the structure. The re-treatment of the structure at post-construction is not feasible without causing considerable property damage and an uneven, ineffective, “hit-or-miss” application philosophy. The floors and exterior walls must be drilled and a termiticide injected below the foundation and floors.

The exterior re-treatment of a structure involves trenching around the perimeter of the structure and then flooding the trench with a termiticide. This time intensive process disturbs the landscaping and can damage plants. Exterior treatments at patio locations would require drilling through the patio surface at 16″ intervals along the exterior wall, again, causing considerable damage to the structure.

### SUMMARY OF THE PRESENT INVENTION

According to the present invention, termite control material is delivered to selected portions of a land mass on which a structure is located, according to a predetermined zoned delivery plan that is based at least on the structure configuration, the entry areas at which entry of termites into the structure is most likely, and the hydraulic limitations of the fluid delivery conduit forming the delivery conduit system. Termite control material is delivered from the fluid delivery conduit system to selected delivery area(s) of the land mass through pressure compensating, root inhibiting emitters at predetermined locations in the chemically resistant fluid delivery conduit of the fluid delivery conduit system.

In one implementation of the principles of the present invention, the predetermined zoned delivery plan is designed to enable termite control material to be delivered to the land mass about the perimeter of the structure. In another implementation, the predetermined zoned delivery plan is designed to enable termite control material to be delivered to area(s) of the land mass that are proximate to locations at which entry of termites into the structure is most likely. In yet another implementation, the predetermined zoned delivery plan is designed to enable deliver termite control material to be delivered to the land mass below the entire foundation of the structure.

In the practice of the present invention, it is preferred that one or more moisture sensors are installed in the land mass, at location(s) that enable monitoring of the depth and lateral coverage of termite control material that is delivered to the delivery area(s) of the land mass. In addition, it is preferred that the fluid delivery conduit system includes a manifold configured to enable termite control material to be delivered to fluid conduit delivery zones in a selective manner, in accordance with a predetermined termite material delivery plan for the structure.

In this application reference to a “predetermined zoned delivery plan” means a plan by which termite control material is delivered to areas of a land mass in a manner that takes into consideration a number of important factors, including the locations at which entry of termites is most likely, the hydraulic limitations of the fluid delivery conduit through which the termite control material is delivered, e.g. for a given conduit diameter, and the available pressure for delivering the termite control material through the conduit, there is a length of conduit at which the delivery through that conduit becomes inefficient, and a zoned delivery plan would then break up the conduit system into portions, each of which covers a predetermined zone of the land mass, and termite control material may be selectively delivered to those portions, so as to most efficiently and effectively deliver the termite control material to the areas to which it needs to be delivered. The “predetermined zoned delivery plan” can be designed for a land mass on which a structure already exists, or for a land mass on which a structure will be constructed.

The system and method of the present invention may be used independently, or in combination, to treat pre- and post-construction. Moreover, the system and method of the present invention can be used to treat, e.g.
1. an entire foundational area, (see FIG. 2), i.e. structures with radiant floor heating, wood flooring installation and other termite attracting environments;
2. all possible interior structural entry points, (see FIGS. 3a-3g), i.e., slab/stem wall interfaces, pipe entry points, air duct returns and interior walls; and
3. an entire exterior perimeter of the structure (FIG. 4).

These and other features of the present invention will become further apparent from the following detailed description and the accompanying drawings.

### BRIEF DESCRIPTION OF THE DRAWINGS

FIGS. 1a and 1b are schematic illustrations of a manifold distribution system for delivering termite control material to a conduit system, according to the principles of the present invention;

FIG. 2 is a schematic layout of a full grid distribution system, for preconstruction, under slab, installation of a termite control delivery system, according to the principles of the present invention;

FIGS. 3a-3g are schematic illustrations of components of a distribution system for preconstruction, under slab, installation of a termite control delivery system to all possible interior structural termite entry points (i.e. slab/stem wall interfaces, pipe entry points, air duct returns and interior walls), according to the principles of the present invention;

FIG. 4 is a schematic layout of a distribution system, for pre or post construction of an exterior perimeter installation of a termite control delivery system, according to the principles of the present invention; and

FIGS. 5a and 5b are schematic illustrations of a a portion of a distribution system, according to the principles of the present invention, showing examples of pressure compensating root inhibiting emitters in such a system.

### DETAILED DESCRIPTION

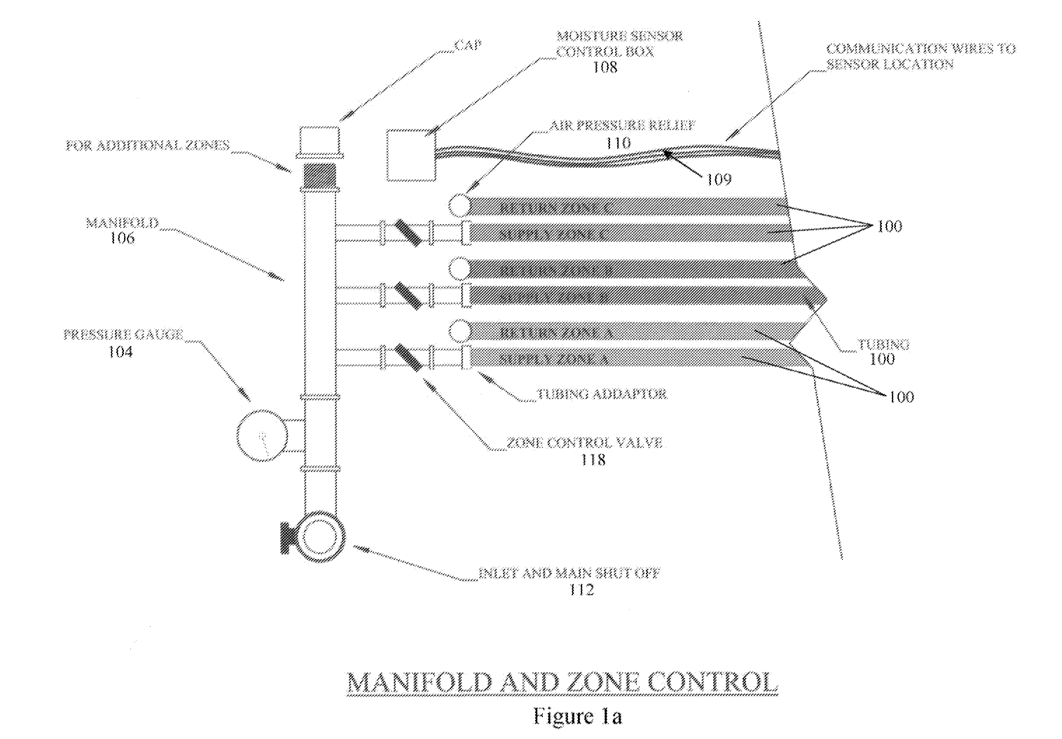

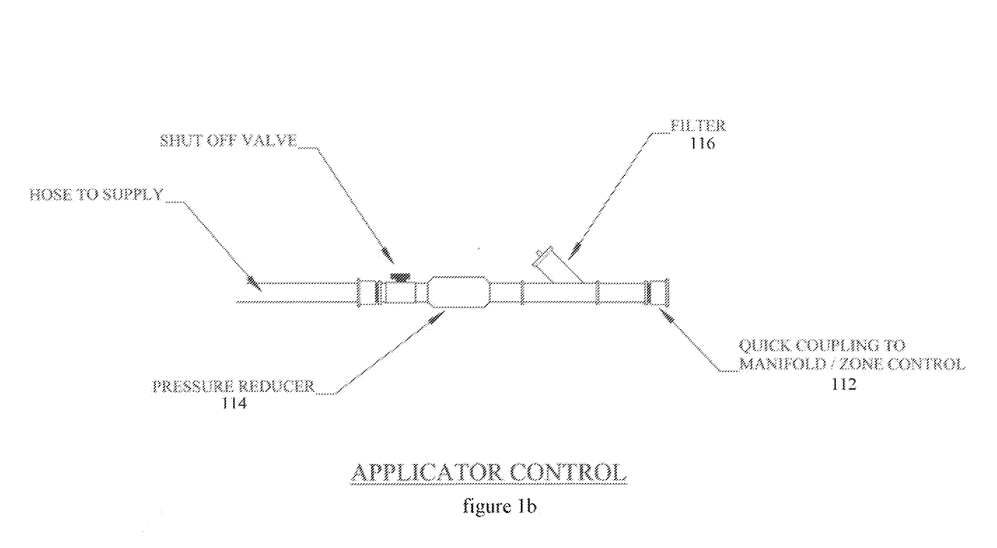

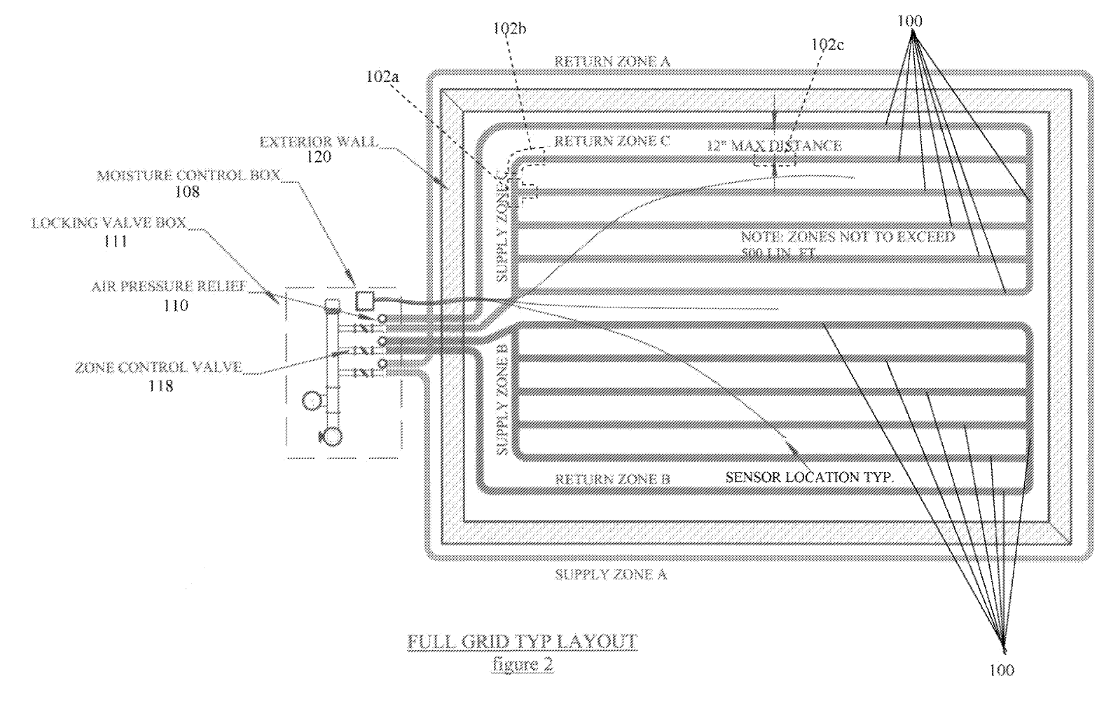

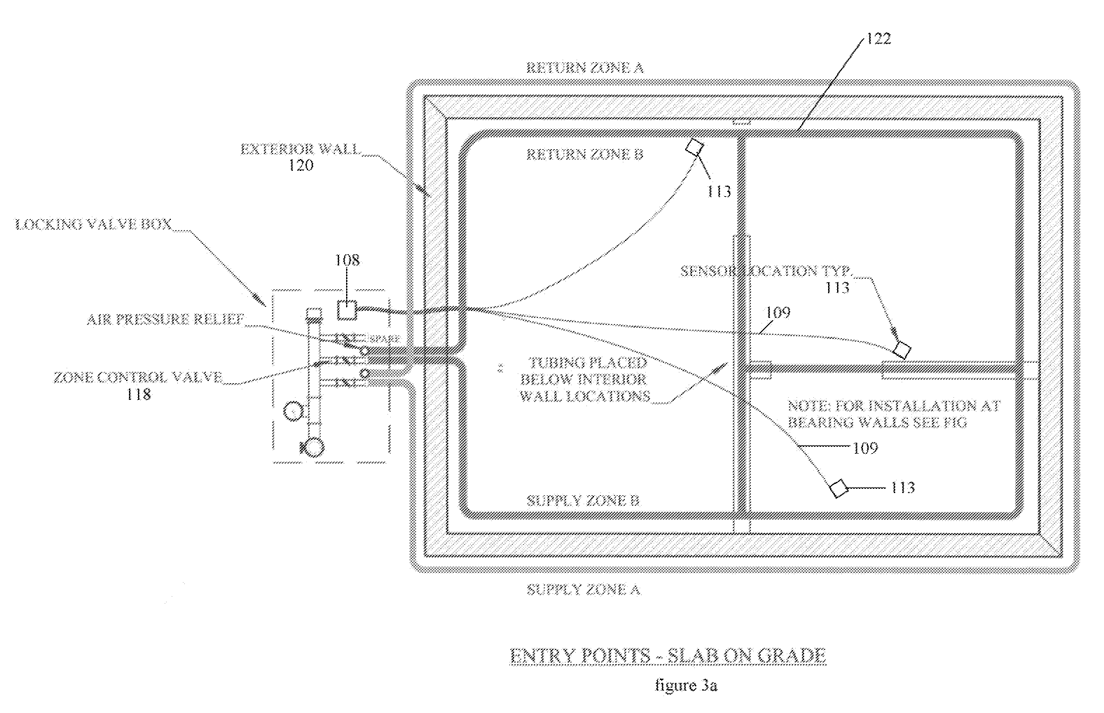

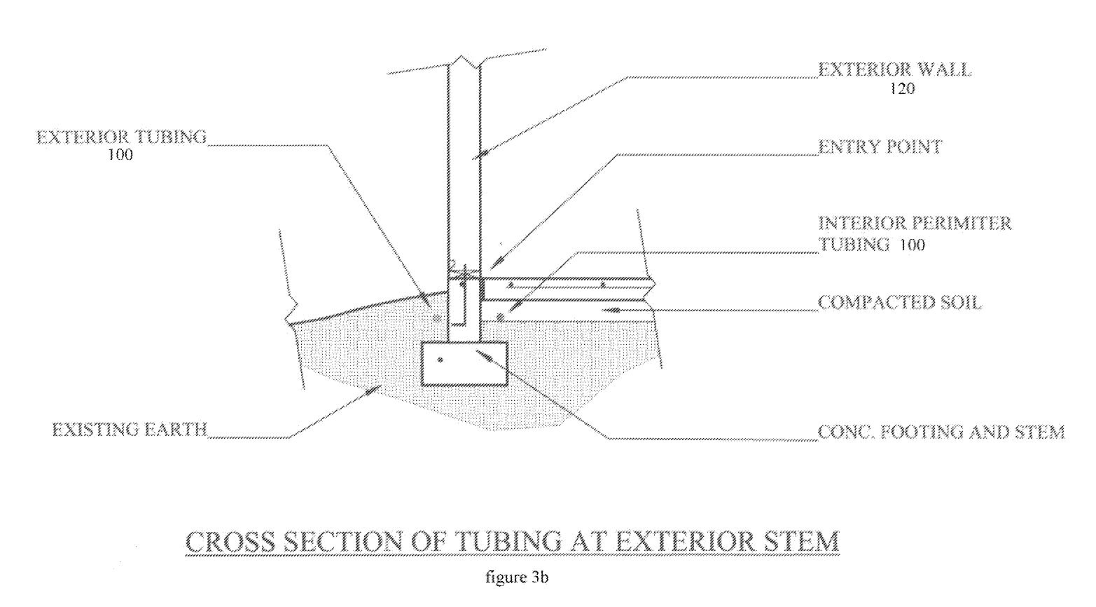

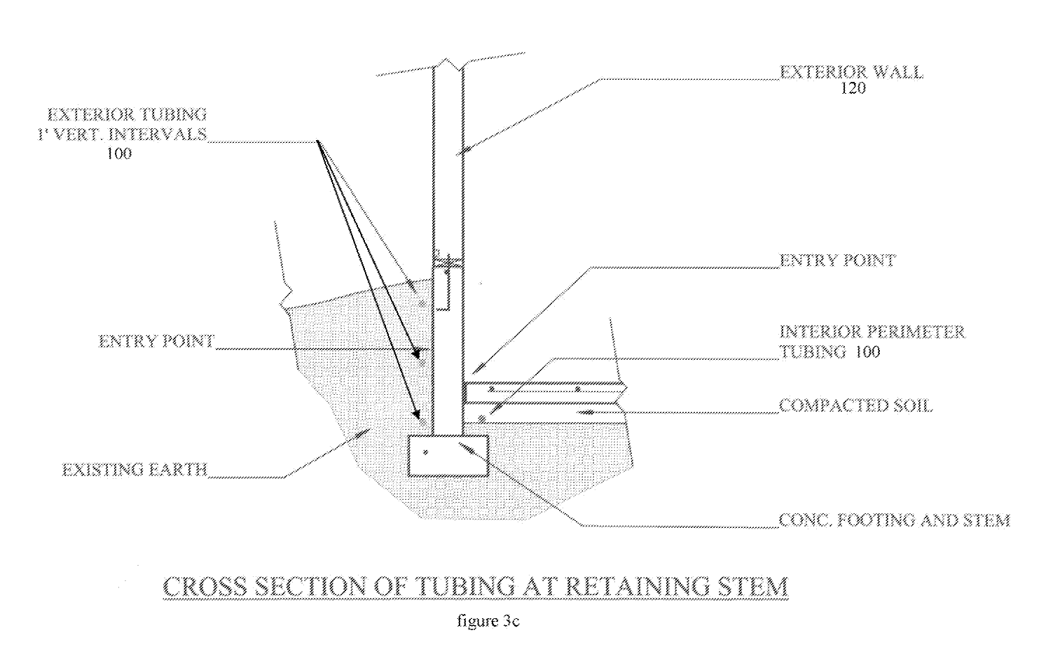

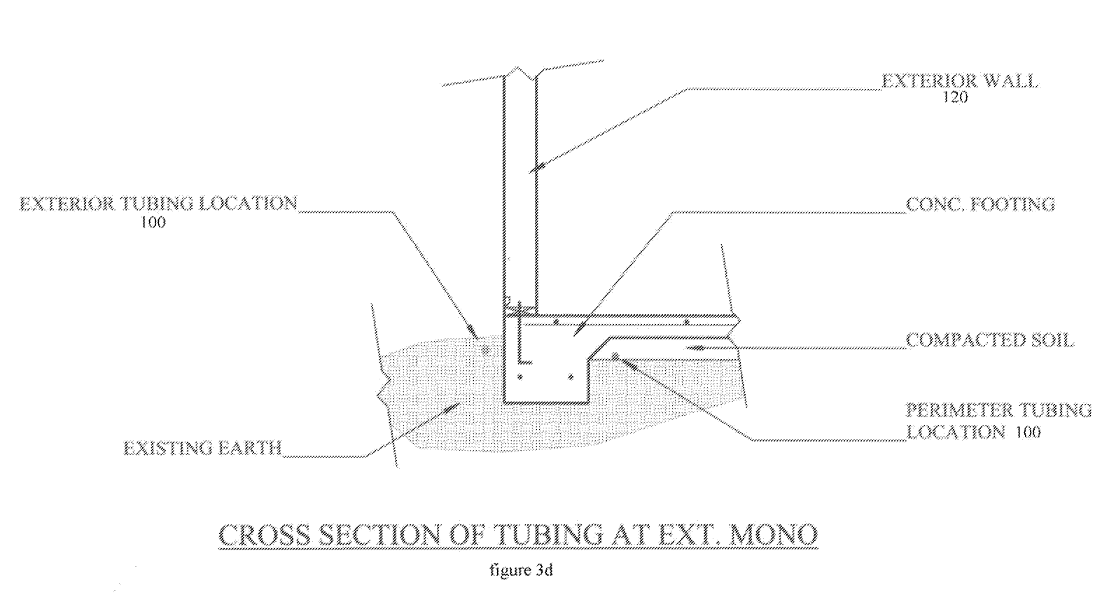

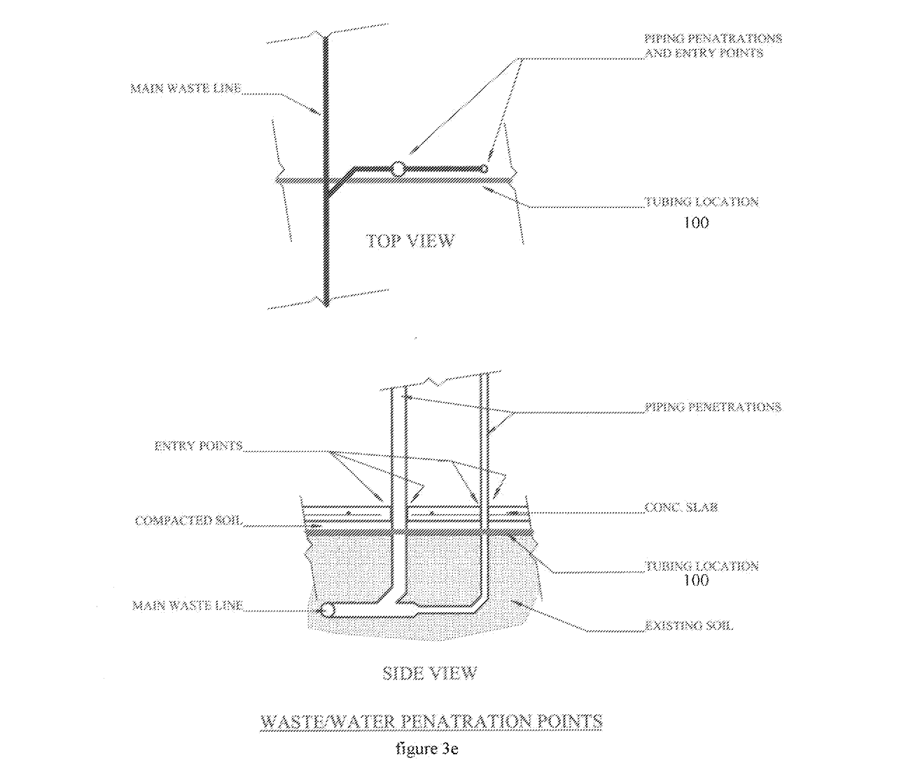

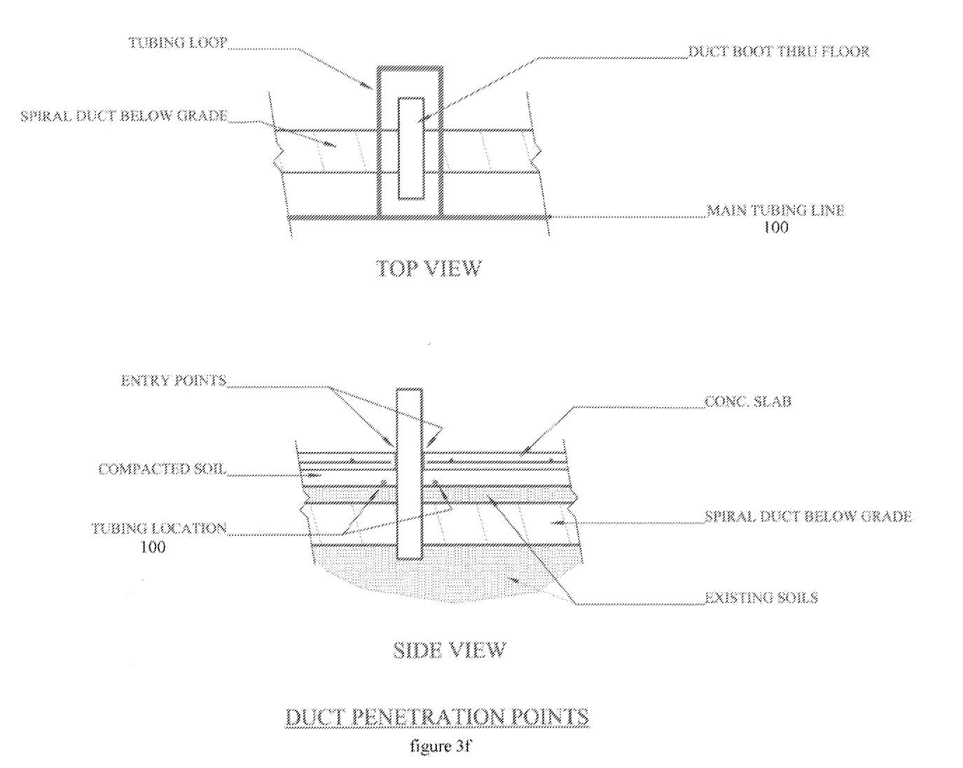

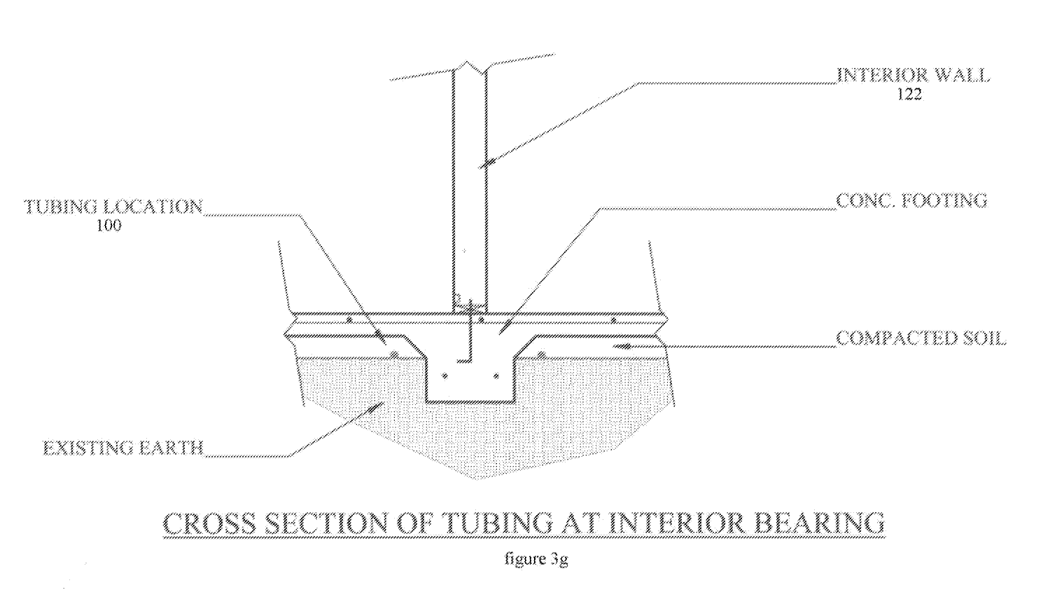

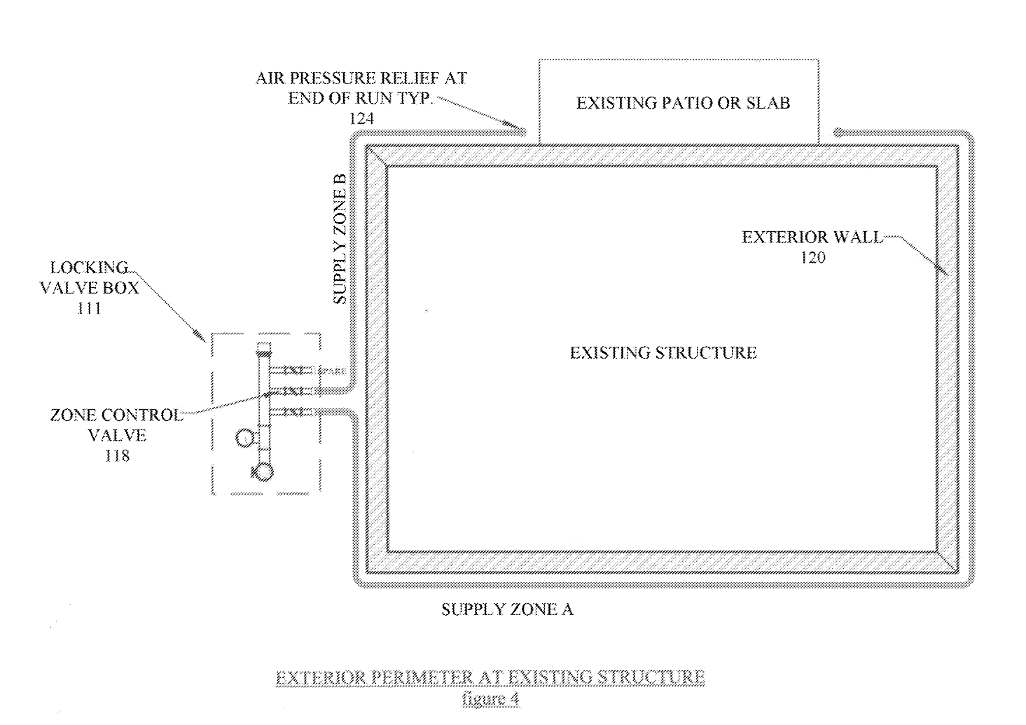

As described above, the present invention provides a method and system for delivering termite control material to selected portions of a land mass on which a structure is located. The principles of the present invention are described herein in connection with a full grid installation (FIGS. 1a, 1b, 2), all interior structural entry points (FIGS. 3a-3g), and also in connection with an exterior perimeter installation (FIG. 4).

According to the invention, termite control material is delivered to selected portions of a land mass on which a structure is located, according to a predetermined zoned delivery plan that is based at least on the structure configuration, the entry areas at which entry of termites into the structure is most likely, and the hydraulic limitations of the fluid delivery conduit forming the delivery conduit system. Termite control material is delivered from the chemically resistant fluid delivery conduit system to selected delivery area(s) of the land mass through pressure compensating, root inhibiting emitters at predetermined locations in the fluid delivery conduit of the fluid delivery conduit system.

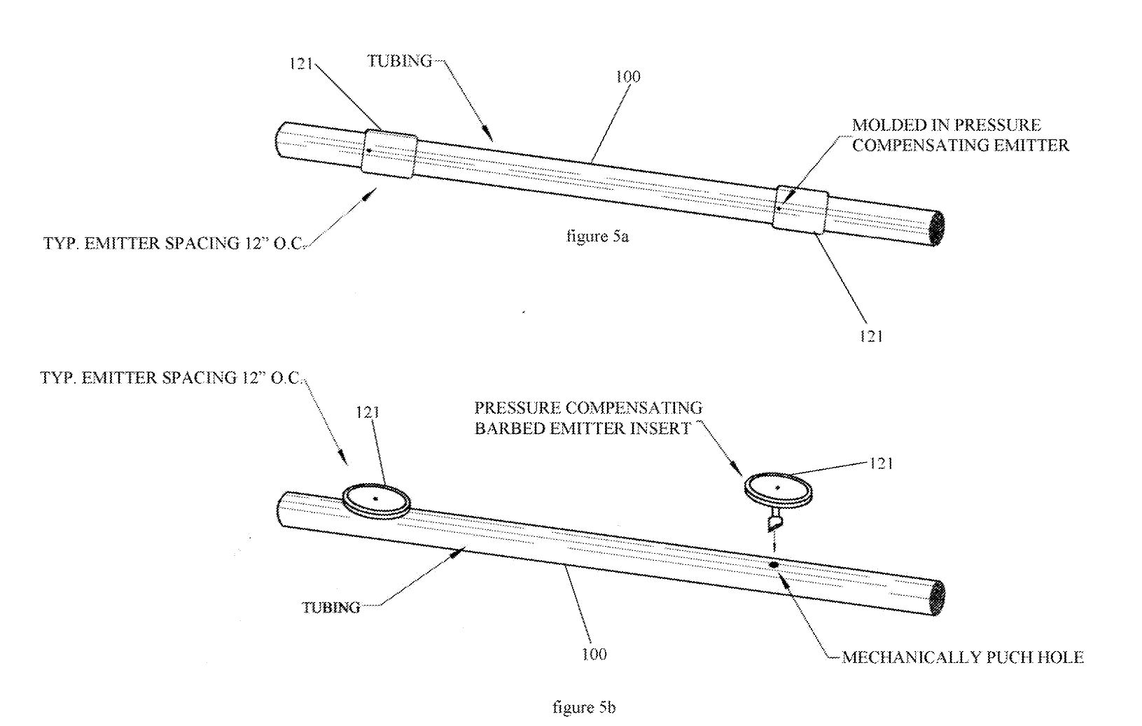

FIG. 2 illustrates a layout of a predetermined full grid zoned delivery layout, for preconstruction, under slab, installation of a termite control delivery system, according to the principles of the present invention. The fluid delivery conduit system illustrated in that figure includes conduit portions 100 located in each of a plurality of delivery zones,that effectively cover the entire area under the foundation of a structure from which termites might enter the structure. Termite control material is delivered to the delivery conduit system, via a manifold distribution system of FIGS. 1a, 1b, and the zoned fluid delivery conduit system of FIG. 2, through pressure compensating emitters 121 at predetermined locations in the delivery conduit system, as shown schematically in FIG. 5, and described further below. FIGS. 3a-3g illustrate a zoned delivery layout plan, for delivery of termite control material to selected delivery area(s) through the structures shown in FIGS. 3a-3g, also through pressure compensating emitters at predetermined locations in the delivery conduit system, as described further below. FIG. 4 illustrates a zoned delivery layout plan for delivery of termite control material to selected areas about a structure perimeter, also through pressure compensating emitters 121 (FIG. 5) at predetermined locations in the delivery conduit system, according to the principles of the present invention, and described further below

The components of a system according to the present invention includes the following principal components:
1. Manifold based distribution system (FIGS. 1a and 1b)
2. Chemically resistant drip tubing with evenly spaced, pressure compensating and root inhibiting emitters 121 (FIG. 5), described further below.
3. Locking drip tubing fittings or couplings (some examples are schematically shown at 102a-c in FIG. 2) to prevent separation of tubing at connection points.
4. Pressure gauge 104 connection at manifold 106 for system testing and validation.
5. Moisture sensors 113 that communicate with a moisture sensor control box 108 for precise monitoring of depth penetration of termiticide.
6. Air relief valve 110 for each zone to prevent possible emitter clogging and tubing connection damaged due to pressure and vacuum conditions.
7. Tubing layout design specific to the structure's requirements and hydraulic limitations of the delivery conduit.
8. Optional injection system for tank-less mixing of termiticide with water.

Components Description:

a) Manifold based distribution system.

Unique to this system is the “Manifold Distribution and Zone Control Center” (FIGS. 1a and 1b) that is provided, e.g., in a locking valve box 111 (FIG. 2). A single service point comprised of a quick coupling connection, a pressure reducing valve 114, filtration system 116 to prevent emitter contamination, an air relief valve for each zone (e.g. a YD-500-34 (Air Vent ½″ MIPT Air Release & Vacuum Relief Valve, from the Toro Micro-Irrigation DL 2000 part series), to prevent damage to the system from excessive pressure during the charging of the system and to prevent a vacuum condition upon depressurization, thus preventing debris from entering the system, control valves, and a pressure valve test connection (associated with pressure gauge 104) to measure initial installation readings and for subsequent testing to determine if system is within parameters and moisture sensor reading location 108 to validate accurate penetration and distribution of the termiticide. The Zone Control Center is contained in a locking valve box 111 indicating chemical attachment location and other applicable warning indicators (e.g., Non-Potable Water Source, Do Not Attached to Potable Water Source, etc.)

From each service location, single, or multiple control valves (zone control valves 118) direct the termiticide to specific zones, or targeted areas, within the structure, or to designated exterior perimeter areas. This service location is also used for the evacuation and testing of the integrity of the distribution system.

The ability to treat, and re-treat, structures, zone by zone, target specific infected zones, and to monitor the desired depth of the applied termiticide, maximizes the effectiveness of the termiticide application while protecting the integrity of the structure and the environment.

b) Chemically tolerant drip tubing with spaced (preferably evenly spaced), pressure compensating and root-inhibiting emitters 121 (see FIG. 5), which can be of the type disclosed in U.S. Pat. Nos. 5,332,160, 5,052,625 (relating to pressure compensating emitters), and U.S. Pat. No. 5,116,414 (relating to long-term control of root growth). Each of the foregoing US patents is incorporated herein by reference.

The pressure compensating drip emitters 121 (U.S. Pat. Nos. 5,332,160; 5,052,625), can be molded into the drip tubing 100 (FIG. 5a), or inserted (punched hole in tubing with inserted barbed emitters) at defined spacing (typically at 12″ intervals) ensure a uniform application of the prescribed termiticide, regardless of the coverage area or location (FIG. 5b). The tubing can be self-flushing, allowing for fresh water evacuation of the system through the emitters, or may utilize emitters that incorporate a check-valve, thus necessitating the evacuation of the system with fresh water or into a recovery tank at the manifold.

The localized, emitter specific, root inhibiting protection, provides long-lasting protection (over 20+ years) to prevent the clogging of the emitters due to intrusive roots both on the interior and exterior of the structure. The use of emitter-specific root inhibitors precludes the problems associated with granular root inhibitors that require re-treatment to the exterior on a regular basis and are impractical for post-construction under-slab treatment.

c) Locking drip tubing fittings to prevent separation of tubing at junction points.

The fittings (e.g. 102a-c, FIG. 2) are designed to prevent de-coupling via a locking mechanism that tightens as the connection is pulled apart, or are threaded couplings that also prevent decoupling. This ensures the integrity of the system for long term. The fittings can be, e.g. Loc-Eze fittings, from the Toro Micro-Irrigation Division, Spin-Loc and Power-Loc fittings by Jain Irrigation, or other similar locking connectors.

d) Pressure gauge connection at manifold for system testing and validation.

The distribution manifold is equipped with a pressure gauge 104 attachment point. This allows for a pressure reading test to be taken upon initial installation, to establish a “bench mark reading” for later comparison to ensure the integrity of the system. The system would be pressurized to a determined level and then a time measurement would be taken for the pressure to return to zero pounds per square inch (PSI.), to determine this bench mark. Prior to subsequent re-treatments, the current reading would be matched against this benchmark before proceeding—(over pressure=clogged emitters, under pressure=break in line).

e) Moisture sensors for real-time monitoring of depth penetration of termiticide.

Remote moisture sensors 113 would be placed at designated locations on the interior and exterior of the structure. These sensors 113 would be positioned at the desired depth of required treatment and at key, or major, entry-point locations. The communication wires 109 are then routed to the manifold location and into a junction box 108 that would allow attachment to a readout display showing when the termiticide injection has reached the desired level. This prevents over, or, under treatment and validates the treatment.

f) Air/Vacuum release valve 110, commonly used in drip irrigation systems, for each zone to prevent possible emitter clogging and tubing damage, at connections, due to pressure and vacuum conditions.

The introduction of a fluid into a tubing or pipe initially creates air pressure as the tubing fills up and trapped air is compressed. If the pressure becomes too great, before it can escape through the emitters, the mechanical connections could be compromised. Conversely, as the system is depressurized, after the source is turned off, a vacuum condition can occur, causing granular material around the emitters to be retracted into the emitter, potentially clogging it.

The incorporation of a simple air relief valve 110 to each zone allows for the escape of trapped air, or, prevents a vacuum condition, thus preventing any harmful effect from occurring.

g) Tubing layout design specific for each of the previously defined applications.

A specific design is required for each application to adequately ensure that all potential termite entry points are covered and zone areas are properly supplied with the required termiticide. Zoning is critically based on the hydraulic limitation of the delivery conduit. Critical factors in any fluid delivery system include, but are not limited to, pipe size, length of pipe, pressure of the fluid delivered and elevation changes. In order to ensure proper distribution, all of these factors must be considered and the zone designed based on these factors. Documents are available to determine application rates, soil infiltration rates and other pertinent information.

h) Optional injection system for tank-less mixing of termiticide with water.

Typically, the termiticide is mixed in a large tank and then pumped into the trenched perimeter or sprayed into the walls and floors of the structure for treatment. This tank process is compatible with this system.

There are commercially available injection system, both mechanical and siphon type that would preclude the use of a mixing tank.

A Mazzie (trademark) injector is described in U.S. Pat. No. 5,863,128, which is incorporated herein by reference. The injection is a non mechanical proven method used to introduce and mix various materials into a water solution. When pressurized water enters the injector inlet, it is constricted toward the injection chamber and changes into a high-velocity jet stream. The increase in velocity through the injection chamber results in a decrease in pressure, thereby enabling an additive material (in our case a termiticide) inlet to be drawn through the suction port and entrained into the water stream. As the jet stream is diffused toward the injector outlet, its velocity is reduced and is reconverted into pressure energy, but a pressure lower than injector inlet pressure (U.S. Pat. No. 5,863,128). This is an optional way of delivering a water/termidicide mixture to the manifold 106 (e.g. though the inlet and main shut off 112)

This injector, and other mechanical injectors, would preclude the need for a large truck to be equipped with a large tank and would facilitate the treatment process.

### Pre-Construction, Under-Slab, Full Grid Installation

### (See FIG. 2)

1) An easily accessible location is selected for the Manifold Distribution System and is installed.

2) Based on the linear square footage of the structure, and other hydraulic limiting factors, and key areas of concern, specific zones and areas are identified for targeted initial and subsequent treatment.

3) Specifically, the entire exterior and interior perimeter of the structure, where the slab interfaces with the structural footings and the entire foundational area are to be covered by the defined tubing, typically with emitters at 12″ intervals.

4) An “Air Relief Valve” 110 is installed, in a valve box, to relieve the air pressure in the lines upon initial pressurization of the system. Additionally, this pressure relief valve 110, upon de-activation, allows the system to depressurize without creating a vacuum in the system that could draw contaminates into the emitters, eliminating the potential of emitter obstruction from debris.

5) The entire piping is installed prior to the final aggregate base (AB) layer, prior to the pouring of the slab. After installation, the system is energized to ensure the integrity of the couplings, emitters and tubing. Subsequent to this initial testing, the final layer of aggregate base (AB) material is applied and compacted. The system is energized again and visually inspected for complete and even distribution and to ensure that no leaks are detected. A pressure test at the manifold 106 would be taken to establish a bench mark for each zone. That information is recorded for future reference. The concrete slab is then poured.

6) Each Zone may be equipped with a moisture sensor 113 placed at a predetermined depth, based on the desired treatment. Additional sensors may be placed at other strategic locations. These sensors verify the desired treatment has been achieved by measuring and validating that the termiticide has been delivered precisely to the level and locations where it is needed, thus preventing under-treatment, or unnecessary over-treatment that may be potentially harmful to the environment. The sensor wires 109 would be routed to the manifold location 108 where they would be connected to a meter during treatment.

7) These sensors 113 may also be used as a system test using potable water without any chemicals. Establishing a baseline upon initial construction, this can be compared to in future years to verify the integrity of the system. The time, at a specific flow rate, that it takes for the moisture to reach the sensor becomes the baseline for that location, independent of soil types.

### Pre-Construction, Under-Slab, Termite Entry-Point Specific Installation

### (See FIG. 3a-3g)

1) An easily accessible location is selected for the Manifold Distribution System and installed.

2) Based on the linear square footage of the structure, and other hydraulic limiting factors, and key areas of concern, specific zones and areas are identified for targeted initial and subsequent treatment. All potential entry points are to be covered by single and/or multiple drip emitter tubing lines using appropriate fittings (e.g. 102a-c) and an air relief valve 110.

3) Specifically, the entire exterior and interior perimeter of the structure, where the slab interfaces with the structural footings, all sub-surface piping lines and entry points through the slab, all mechanical air duct returns, all interior wall locations and any other entry points through the foundation are to be covered by the defined tubing

4) The tubing is installed along all of the perimeter walls 120 and installed directly in line with interior piping penetrations and interior walls 122 (see FIGS. 3a, 3g). For large entry points, a square, or loop, is arranged around large entry points through the concrete slab. The drip lines are secured with “U” shaped soil staples.

5) An “Air Relief Valve” 110 is installed, in the valve box, to relieve the air pressure in the lines upon initial pressurization of the system. Additionally, this pressure relief valve, upon de-activation, allows the system to depressurize without creating a vacuum in the system that could draw contaminates into the emitters, eliminating the potential of emitter obstruction from debris.

6) The entire piping (tubing) is installed prior to the final aggregate base (AB) layer, prior to the pouring of the slab. After installation, the system is energized to ensure the integrity of the couplings, emitters and tubing. Subsequent to this initial testing, the final layer of AB material is applied and compacted. The system is energized again and visually inspected for complete and even distribution and to ensure that no leaks are detected. A pressure test at the manifold 106 would be taken to establish a bench mark for each zone. That information is recorded for future reference. The concrete slab is then poured.

7) Each Zone may be equipped with a moisture sensor 113 placed at a predetermined depth, based on the desired treatment. Additional moisture sensors may be placed at other strategic locations. These sensors verify the desired treatment has been achieved by measuring and validating that the termiticide has been delivered precisely to the level and locations where it is needed, thus preventing under-treatment, or unnecessary over-treatment that may be potentially harmful to the environment. The sensor wires 109 would be routed to the manifold location 108 where they would be connected to a meter during treatment.

8) These sensors may also be used as a system test using potable water without any chemicals. Establishing a baseline upon initial construction, this can be compared to in future years to verify the integrity of the system. The time, at a specific flow rate, that it takes for the moisture to reach the sensor becomes the baseline for that location, independent of soil types.

### Pre or Post Construction—Exterior Perimeter Installation

### (See FIG. 4)

1) An easily accessible location is selected for the Manifold Distribution System and installed.

2) Based on the linear square footage of the exterior structure, and other hydraulic limiting factors, and key areas of concern, specific zones and areas are identified for targeted initial and subsequent treatment.

3) An “Air Relief Valve” 124 is installed, in a valve box, to relieve the air pressure in the lines upon initial pressurization of the system. Additionally, this pressure relief valve, upon de-activation, allows the system to depressurize without creating a vacuum in the system that could draw contaminates into the emitters, eliminating the potential of emitter obstruction from debris.

4) Adjacent to the exterior perimeter wall 120, a trench is excavated to the footing level of the structure. The drip tubing is then installed around the entire perimeter. Depending on the depth of the footing, multiple layers at 1-foot vertical intervals may be installed (see FIG. 3c).

5) The entire piping is installed, at each vertical level, prior to the backfilling of the trench at that level. The system is then energized to ensure the integrity of the couplings, emitters and tubing. The system is energized again and visually inspected for each level. A pressure test at the manifold would be taken to establish a bench mark for each level or zone. That information is recorded for future reference.

6) Each zone and/or level is equipped with a moisture sensor placed at a predetermined depth, based on the desired treatment. Additional sensors may be placed at other strategic locations. These sensors verify the desired treatment has been achieved by measuring and validating that the termiticide has been delivered precisely to the level and locations where it is needed, thus preventing under-treatment, or unnecessary over-treatment that may be potentially harmful to the environment. As described in connection with the system of FIG. 2, the sensor wires would be routed to the manifold location where they would be connected to a meter during treatment.

7) These sensors may also be used as a system test using potable water without any chemicals. Establishing a baseline upon initial construction, this can be compared to in future years to verify the integrity of the system. The time, at a specific flow rate, that it takes for the moisture to reach the sensor becomes the baseline for that location, independent of soil types.

Thus, as seen from the foregoing description, applicants' system and method is designed to deliver termite control material to selected portions of a land mass on which a structure is located, according to a predetermined zoned delivery plan that is based at least on the structure configuration, the entry areas at which entry of termites into the structure is most likely, and the hydraulic limitations of the fluid delivery conduit forming the delivery conduit system. Termite control material is delivered from the fluid delivery conduit system to selected delivery area(s) of the land mass through pressure compensating, root inhibiting emitters at predetermined locations in the fluid delivery conduit of the fluid delivery conduit system. In one implementation of the principles of the present invention, the predetermined zoned delivery plan is designed to enable termite control material to be delivered to the land mass about the perimeter of the structure. In another implementation, the predetermined zoned delivery plan is designed to enable termite control material to be delivered to area(s) of the land mass that are proximate to locations at which entry of termites into the structure is most likely. In yet another implementation, the predetermined zoned delivery plan is designed to enable deliver termite control material to be delivered to the land mass below the entire foundation of the structure.

With the foregoing description, the manner in which various specific systems and methods can be designed to deliver termite control material to selected portions of a land mass on which a structure is located, both pre and post construction of the structure on the land mass, will be apparent to those in the art.

1. A method of delivering termite control material to selected portions of a land mass on which a structure is located, including installing a fluid delivery conduit system according to a predetermined zoned delivery plan that is based at least on the structure configuration, the entry areas at which entry of termites into the structure is most likely, and the hydraulic limitations of the fluid delivery conduit forming the delivery conduit system, and delivering termite control material from the fluid delivery conduit system to selected delivery area(s) of the land mass through pressure compensating, root inhibiting emitters at predetermined locations in the fluid delivery conduit of the fluid delivery conduit system.

2. The method of claim 1, wherein the predetermined zoned delivery plan is designed to enable termite control material to be delivered to the land mass about the perimeter of the structure.

3. The method of claim 1, wherein the predetermined zoned delivery plan is designed to enable termite control material to be delivered to area(s) of the land mass that are proximate to locations at which entry of termites into the structure is most likely.

4. The method of claim 1, wherein the predetermined zoned delivery plan is designed to enable deliver termite control material to be delivered to the land mass below the entire foundation of the structure.

5. The method of claim 1, wherein the one or more moisture sensors are installed in the land mass, at location(s) that enable monitoring of the depth of termite control material that is delivered to the delivery area(s) of the land mass.

6. The method of claim 1, wherein the fluid delivery conduit system includes a manifold configured to enable termite control material to be delivered to fluid conduit delivery zones in a selective manner, in accordance with a predetermined termite material delivery plan for the structure.

7. A system for delivering termite control material to selected portions of a land mass on which a structure is located, comprising a fluid delivery conduit system installed in the land mass according to a predetermined zoned delivery plan that is based at least on the structure configuration, the entry areas at which entry of termites into the structure is most likely, and the hydraulic limitations of the fluid delivery conduit forming the delivery conduit system, the fluid delivery system configured to deliver termite control material from the fluid delivery conduit system to selected delivery area(s) of the land mass through pressure compensating, root inhibiting emitters at predetermined locations in the fluid delivery conduit of the fluid delivery conduit system.

8. The system of claim 7, wherein the fluid delivery conduit system is installed in a manner that enables termite control material to be delivered to the land mass about the perimeter of the structure.

9. The system of claim 7, wherein the fluid delivery conduit system is installed in a manner that enables termite control material to be delivered to area(s) of the land mass that are proximate to locations at which entry of termites into the structure is most likely.

10. The system of claim 7, wherein the fluid delivery conduit system is installed in a manner that enables termite control material to be delivered to the land mass below the entire foundation of the structure.

11. The system of claim 7, wherein one or more moisture sensors are installed in the land mass, at location(s) that enable monitoring of the depth of termite control material that is delivered to the delivery area(s) of the land mass.

12. The system of claim 7, wherein the fluid delivery conduit system includes a manifold configured to enable termite control material to be delivered to fluid conduit delivery zones in a selective manner, in accordance with a predetermined termite material delivery plan for the structure.

13. A system for delivering termite control material to selected portions of a land mass on which a structure is located, comprising dividing the land mass into delivery zones according to a delivery layout, each delivery zone including an entry area at which entry of termites into the structure is most likely and zoned specifically on the hydraulic limitation of the delivery conduit, a fluid delivery conduit system, including conduit portions located in each delivery zone, each conduit portion in predetermined proximity to the entry area(s) in the delivery zone, each of the conduit portions configured to deliver termite control material from the delivery conduit system to selected delivery area(s) through pressure compensating, root inhibiting emitters at one or more predetermined locations in the conduit portion, and the conduit system being configured to deliver termite control material to the selected delivery area(s).
